(19) United States
(12) Patent Application Publication
(10) Pub. No.: US 2021/0323529 A1
(43) Pub. Date: Oct. 21, 2021

(54) CONTROL MODULE OF AN AIR TREATMENT SYSTEM OF A UTILITY VEHICLE

(71) Applicant: WABCO GMBH, Hannover (DE)

(72) Inventors: Heinrich DIEKMEYER, Barsinghausen (DE); Joachim HEIDER, Peine (DE); Dirk HILLBRING, Celle (DE); Andreas TEICHMANN, Isernhagen (DE)

(21) Appl. No.: 17/273,161

(22) PCT Filed: Aug. 2, 2019
(86) PCT No.: PCT/EP2019/070852

§ 371 Date: Mar. 3, 2021

(30) Foreign Application Priority Data
Sep. 3, 2018 (DE) 10 2018 121 384.0

(51) Int. Cl. B60T 17/00; B60T 17/02; B60T 17/04; F15B 13/08

(52) U.S. Cl. CPC B60T 17/004; B60T 17/02; B60T 17/04; F15B 13/0853; F16K 27/003; F15B 13/0842; F15B 13/085; F15B 13/086; F15B 13/0857

(57) ABSTRACT

A control module for an air treatment system of a utility vehicle comprises the following: a first and second pneumatic magnetic valve having a first or second coil, connecting pins, and armatures accommodated in the coils, a circuit carrier, and a module housing that is cast from a plastic material, into which housing the coils are cast. The connecting pins project from a first side of the module housing and are electrically connected to the circuit carrier. A plug-in connection for receiving a connection plug is formed in the module housing, wherein the plug-in connection has plug-in pins, which extend through the module housing and are electrically connected to the circuit carrier. The module housing has a mounting surface having pneumatic connections for installation on an air dryer housing of an air dryer.

### CROSS-REFERENCE TO RELATED APPLICATIONS

This application is the National Stage of International Application No. PCT/EP2019/070852, filed on 2 Aug. 2019, which claims priority to and all advantages of German Patent Application No. 10 2018 121 384.0, filed on 3 Sep. 2018, the contents of which are hereby incorporated by reference.

### FIELD OF THE DISCLOSURE

The invention relates to a control module of an air treatment system of a commercial vehicle and such an air treatment system.

### BACKGROUND

Control modules for air treatment systems can have different constructions for accommodating a few or multiple functional parts of the electropneumatic air treatment system.

DE 10 2004 051 309 A1 describes an electronic control unit having a function logic circuit in which the solenoid valves and the microprocessor can also be accommodated.

DE 10 333 610 B4 describes a module comprising solenoid valves and an ECU, which serves to control the air treatment and air suspension. DE 103 14 643 A1 describes a control device having solenoid valves for an air suspension.

DE 10 200 501 8888 B4 describes a valve construction, in which multiple housings are flange-connected to one another. In this case, solenoid valves are also accommodated for direct control of a circuit.

DE 10 200 50 263 42 A1 describes a compressed-air supply device having an electronic treatment system, which has a valve housing. A parking brake system module for the compressed-air supply of a parking brake system is arranged on the valve housing via a flange connection.

DE 10 2005 026 343 A1 describes a further air supply device having an electronic air treatment system, which comprises a valve housing, for which an upper side is defined, and a dryer unit. At least one module is arranged laterally on the valve housing via at least one flange connection so that the at least one flange connection provides an electric and a pneumatic interface.

In DE 10 2005 026 344 A1, the valve housing is connected to an air suspension module via a flange connection, wherein the flange connection provides an electric and a pneumatic interface.

DE 10 2006 034 785 A1 describes the design of a compressed-air treatment device having a housing, in which circuit safety valves, an ECU and possibly sensors are accommodated.

Such designs are accordingly often complex and only enable the subsequent replacement of parts with considerable effort. Accordingly, the air treatment systems often have large dimensions in order to accommodate the multiple assemblies.

The invention is therefore based on the object of creating a control module for an air treatment system of a commercial vehicle, which can be formed with little effort, enables a compact construction and a simple connection of the relevant components and can be used for different air treatment systems.

### BRIEF SUMMARY

Disclosed is a control module for an air treatment system of a commercial vehicle. The control module has:

a first pneumatic solenoid valve having a first coil, first connection pins and a first armature accommodated in the first coil,

a second pneumatic solenoid valve having a second coil second connection pins and a second armature accommodated in the second coil,

a circuit carrier, and

a module housing, which is cast from a plastic material and into which the first coil and the second coil are cast,

wherein the first and second connection pin project from a first side of the module housing and are electrically connected to the circuit carrier, a plug-in connection for accommodating a connection plug is formed in the module housing, wherein the plug-in connection has plug-in pins which extend through the module housing, project from the first side of the module housing and are electrically connected to the circuit carrier, wherein the circuit carrier is covered or protected by a cover, which is fastened on the module housing, wherein the module housing has a mounting surface for contact with an air dryer housing of an air dryer, and wherein pneumatic connections of the first solenoid valve and the second solenoid valve are provided or exposed at the mounting surface.

The inventive control module therefore has two solenoid valves, which are cast into a module housing made from plastic material by means of their outer coils. Connection pins of the coils of the two solenoid valves project at a first side, in particular upper side of the module housing, and are electrically connected to a circuit carrier, which can be a PCB (printed circuit board), for example. The circuit carrier is accommodated in a cover, which is fastened on the module housing. A plug-in connection for accommodating a connection plug is furthermore formed in the module housing, in particular on the second side, i.e. in particular the underside of the module housing. Electrical plug-in pins of the plug-in connection extend through the module housing to the first side of the module housing, emerge from the first side of the module housing and—like the connection pins of the coils—are electrically contacted at the circuit carrier.

This already ensures a compact structure and simple manufacturability. In this regard, the coils of the solenoid valves can be cast directly into the plastic material of the module housing, wherein the electrical plug-in connection can also be formed directly on the second side of the module housing, for example in that a plug socket is formed in the module housing, which plug socket surrounds the electrical plug-in pins and is suitable for accommodating the connection plug in a form-fitting manner. Simple electrical contactability is therefore possible The module housing can therefore be formed in that, for example, the solenoid valves are suitably positioned, i.e. with their connection pins projecting upward, and the solenoid valves and the plug-in pins are then cast into the plastic material of the module housing so that the connection pins of the coils and the plug-in pins project freely to the first side (upper side). The yoke of the two solenoid valves is also advantageously cast-in in each case.

To this end, the electrical plug-in pins can be formed, for example, as linear pins, which are cast into the module housing by means of their central region. The circuit carrier can, in particular, be pressed or pushed onto the connection pins of the two coils and onto the plug-in pins of the plug-in connection, for example by means of continuous press contacts of the circuit carrier, whereby procedurally simple and reliable stable contacting is achieved.

The circuit carrier, for example a printed circuit board, is accommodated, for example inserted or mechanically latched, in a cover, or even cast-in when the cover is formed as a die-cast housing. The cover having the circuit carrier can then be seated, for example directly, on the first side (upper side) of the module housing, so that the connection pins and plug-in pins latch in contacts of the printed circuit board, wherein the connection pins and plug-in pins can be pushed through press contacts of the circuit carrier and thereby establish the electrical contacting. However, it is furthermore also possible that the circuit carrier is firstly installed and contacted by the connection pins and plug-in pins and the cover is then installed and fastened on the module housing.

By means of such an arrangement, in which a circuit carrier is installed on the module housing and is reliably accommodated between a cover and the module housing accommodating the valves, a compact construction is enabled, which reliably protects the circuit carrier having the contacts and the electrical functional parts. The cover can have a lower edge, for example, which encompasses the module housing circumferentially, advantageously with a sealing ring between them for sealing contact.

The microcontroller or the electronic control device can be advantageously mounted on the circuit carrier, i.e. in particular on its first or second side, so that the control module already has the solenoid valves and also the process algorithms for the operating modes of the air treatment system. The electronic control device is therefore reliably accommodated between the cover and the module housing, wherein direct and reliable contacting, which is, in particular, also stable with respect to shocks, can be established by the connection pins.

According to a preferred design, a mounting surface of the control module is formed directly as a lateral surface of the module housing, or as a sub-region of a lateral surface. Therefore, the control module can be directly seated on, and pneumatically connected to, an air dryer by means of its module housing. In this case, pneumatic connections of the solenoid valves, i.e. in particular pneumatic connections of the armatures with, for example, suitable sealing surfaces, advantageously lie toward the mounting surface project freely beyond the mounting surface so that they are seated directly in corresponding pneumatic sockets of the air dryer when the control module is seated on the air dryer housing. Therefore, pneumatic connections and furthermore the sealing contact between the module housing and the air dryer unit can be established during installation.

In turn, a very compact construction is thus ensured, wherein undesired leakage caused by split lines etc. can also be reliably prevented as a result of the direct connection. This selected design is compact and robust with respect to mechanical shocks.

In addition to the connection pins of the solenoid valves and the electrical contacting of the connection plug, a pneumatic measuring connection can furthermore be provided on the module housing to measure the pressure in a connected line, for example a supply pressure or the pressure in a connected consumer circuit, by means of a pressure sensor. To this end, the pneumatic measuring connection can be exposed downward on the underside or second side of the module housing and extend upward through the module housing to a pneumatic connection socket at the upper side or first side of the module housing, wherein the pressure sensor mounted and contacted on the circuit carrier can be seated in the pneumatic connection socket from above. Therefore, the measurement signals of the pressure sensor can be read out directly at the line carrier without requiring the complex connection of pneumatic pipes or lines to the pressure sensor. The pneumatic measuring connection can be formed, in particular, on the mounting surface and therefore accommodated directly on the air dryer housing, wherein it is in turn reliably protected as a result of this direct contact.

To ensure the above-mentioned functionalities, the module housing can be formed with a valve block accommodating the solenoid valves and by a connection part, wherein the electrical plug-in connection for data communication and for power supply is provided on the connection part and the pneumatic measuring connection can preferably also be formed thereon. The connection part can be narrower than the valve block and can therefore be formed in an offset manner on the underside or second side, whereby the pneumatic plug-in connection and the pneumatic measuring connection are in turn protected.

### BRIEF DESCRIPTION OF DRAWINGS

The foregoing aspects and many of the attendant advantages will become more readily appreciated as the same becomes better understood by reference to the following detailed description, when taken in conjunction with the accompanying drawings, wherein like reference numerals refer to like parts throughout the various views, unless otherwise specified:

FIG. 1 shows a side view of a control module according to an embodiment of the invention;

FIG. 2 shows a section through the control module of FIG. 1 according to one embodiment;

FIG. 3 shows a section through a control module according to a further embodiment with an accommodated electronic control device;

FIG. 4 shows an electropneumatic circuit diagram of an air treatment system with the control module according to an embodiment of the invention;

FIG. 5 shows an electropneumatic circuit diagram of an air treatment system with the control module according to a further embodiment; and

FIG. 6 shows the air treatment system according to one hardware design.

### DETAILED DESCRIPTION

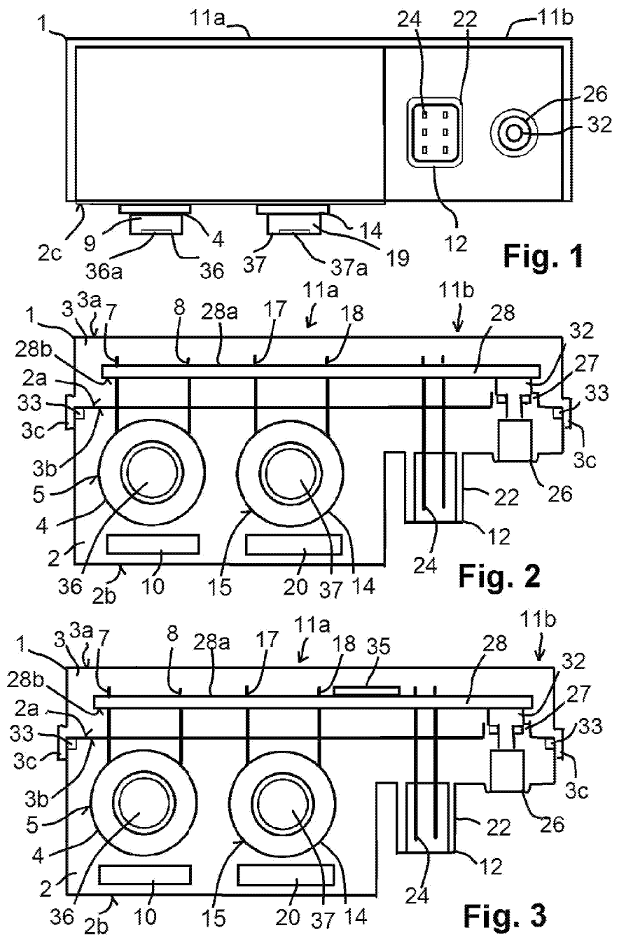

A control module 1 has, according to FIG. 1, 2, a module housing 2 formed as a die-cast body and a cover 3. A first solenoid valve 4 and a second solenoid valve 14 are cast in the module housing 2. The first solenoid valve 4 has a first coil 5, which is generally wound from a first copper wire, wherein the first coil is contacted via first connection pins 7, 8. A first armature 9, which is partially adjustable by the magnetic field of the first coil 5, is accommodated in the first coil 5. Furthermore, the first solenoid valve 4 generally has a first yoke 10 for closing the first magnetic field of the first coil 5, wherein the first yoke 10 can be seen in the section of FIG. 2 and generally extends to above and below the first coil 5.

The second solenoid valve 14 accordingly has a second coil 15 made from a second copper wire, second connection pins 17, 18 and a second armature 19 accommodated in the second coil 15, wherein the second magnetic field of the second coil 15 is closed accordingly by a second yoke 20.

The two coils 5, 15 and the two yokes 10, 20 are accommodated in the plastic material of the module housing 3, wherein the armatures 9 and 19 are accordingly partially adjustable in the coils 5, 15. The connection pins 7, 8, 17, 18 project out of an upper side 2a of the module housing 2. Furthermore, an electrical plug-in connection 12 is formed in the module housing 2, which plug-in connection has a plug socket 22 formed from the plastic material of the module housing 2, for example with a substantially rectangular cross-section according to FIG. 1, 2, and multiple, for example six, electrical plug-in pins 24 within the plug socket 22 so that an electrical connection plug for a power supply and, in particular for a bus connection, can be inserted into the plug-in connection 12, i.e. accordingly from below in FIG. 2. According to FIG. 2, the plug-in pins 24 project through the module housing 2 and emerge upward from the upper side 2a. Optionally and according to the embodiment shown here, a pneumatic measuring connection 26 for a pressure sensor 32 is furthermore formed in the module housing 2, wherein the pneumatic measuring connection 26 has, for example, a circular cross-section and extends from the underside 2b of the module housing 2, through the module housing 2, to the upper side 2a and, at the upper side 2a, accordingly forms a socket opening 27 to which the pressure sensor 32 is connected.

The cover 3 can in turn be formed, in particular, as a cast housing, for example as a die-cast part, or, for example, also as a pressed part from plastic material. A printed circuit board 28 serving as a circuit carrier is covered or protected by the cover 3. When the cover 3 is formed as a cast part, the printed circuit board 28 can be injection molded accordingly on its upper side 28a and its lateral surfaces; alternatively to this, the printed circuit board 28 is subsequently inserted into the cover 3. The printed circuit board 28 accommodates the connection pins 7, 8; 17, 18 of the two solenoid valves 4 and 14, wherein the connection pins 7, 8; 17, 18 can be pushed into the printed circuit board 28, preferably pushed through into press contacts of the printed circuit board 28; alternatively to this, they can also be soldered to contacts of the printed circuit board 28. Accordingly, the plug-in pins 24 of the electrical plug-in connection 12 are also accommodated on the printed circuit board 28, i.e. pushed in, pushed through and/or soldered.

According to the embodiment shown here, the pressure sensor 32 is mounted and electrically contacted on the underside 28b of the printed circuit board 28, wherein the pressure sensor 32 projects into the connection socket 27 of the module housing 22 and is accommodated therein, sealed via seals for example, so that the pressure sensor 32 can measure a pressure applied at the pneumatic measuring connection 26, in particular for measuring the system pressure or the pressure in a connected consumer circuit.

According to FIG. 2, in particular, the cover 3 advantageously encompasses the module housing 2, i.e. it projects around the module housing 2 by means of an outer edge 3c, wherein a seal, for example a sealing ring 33 for sealing the connection between the upper side 2a of the module housing 2 and the underside 3b of the cover 3, is preferably provided.

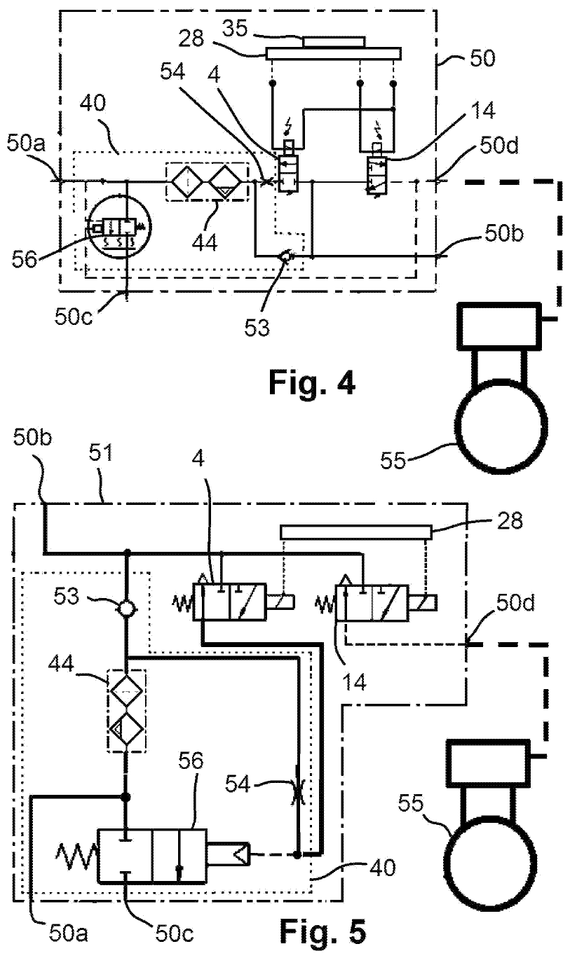

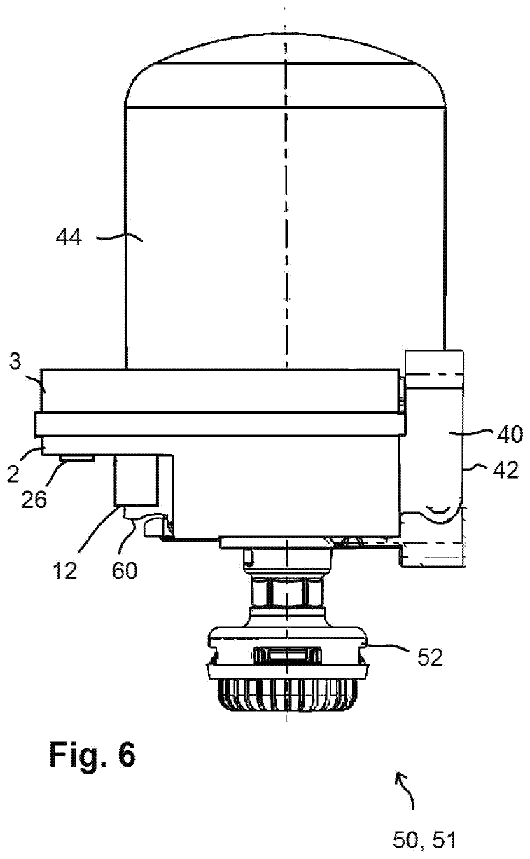

The module housing 2 preferably has a left valve block 11a in FIGS. 1 to 3, into which the solenoid valves 4, 14 are cast, and a right connection part 11b, on which the electrical plug-in connection 12 and the pneumatic measuring connection 26 are formed. The connection part 11b is designed to be slimmer than the valve block 11a so that the connections 12, 26 are offset and thus protected. A mounting surface 2c, which can be seen in FIG. 1, is formed on the valve block 11a, which mounting surface therefore represents a lateral surface of the substantially square left region of the module housing 2. The solenoid valves 4, 14 advantageously project beyond the mounting surface 2c, for example by means of a first pneumatic connection 36 and a second pneumatic connection 37 of their inner armatures 9, 19, wherein rubber seals 36a, 37a, for example, are fitted in the pneumatic connections 36, 37. An air dryer 40 (shown in FIGS. 4 and 6) is connected to the mounting surface 2c, the air dryer housing 42 of which is seated directly on the mounting surface 2c so that the solenoid valves 4, 14 can be accordingly connected directly in the air dryer 40.

According to the embodiment of FIG. 3, an electronic control unit (microcontroller) 35 is furthermore mounted, i.e. fastened and electrically contacted, on the printed circuit board 28. In this case, the electronic control device 35 serves to control the solenoid valves 4 and 14, amongst other things; furthermore, it reads out a pressure measurement signal of the pressure sensor 32 and is connected to a bus system and an electrical power supply of the vehicle via the plug-in pins 24. To this end, according to the design in FIG. 6, an electrical connection plug 60 is plugged into the plug-in connection 12 as a CAN bus connection and for the electrical power supply.

The control module 1 of the embodiments of FIGS. 1 to 3 therefore already enables the required electrical and electropneumatic functions, i.e. the switching of the solenoid valves 4, 14 to initiate different operating modes of an air treatment system 50 of a vehicle, the data communication via a bus system and the electrical power supply and possibly a pneumatic pressure measurement. By fitting or directly mounting the control module 1 on the air dryer 40, an air treatment system shown in FIG. 6 is therefore formed as a block which is compact and also ensures good reliability owing to the lack of exposed wiring. According to FIG. 6, the control module 1 is seated directly on the air dryer housing 42 on which an air dryer cartridge 44 is also replaceably installed, for example via a screw closure or bayonet closure. A sound absorber 52 for a common air outlet is furthermore connected in FIG. 6.

FIGS. 4 and 5 show electropneumatic air treatment systems 50, 51 in which the control module 1 is inserted:

The air treatment system 50 according to FIG. 4 is provided for the connection of a compressor 55 and has the first solenoid valve 4, the second solenoid valve 14 and the air dryer 40—indicated here—with a non-return valve 53, a throttle 54 and a vent valve (purge valve) 56. The compressor 55 is connected to a compressed-air input 50a and, in delivery mode, delivers compressed air into a compressed-air inlet 50a of the air treatment system 50. In delivery mode, the compressed air is delivered through the air dryer cartridge 44 and the non-return valve 53 to a compressed-air output 50b for connected consumer circuits and possibly a compressed-air supply. The first solenoid valve 4 serves here as a regenerative solenoid valve; the second solenoid valve 14 serves here as a governor solenoid valve or control solenoid valve; however, the two solenoid valves 4, 14 of FIGS. 1 to 3 can essentially also be provided in an inverse arrangement. In regenerative mode, the electronic control device 35 outputs electrical control signals to the two solenoid valves 4, 14 so that these switch accordingly. The regenerative solenoid valve 4 is therefore switched to its open position and enables a regenerative flow from the compressed-air output 50b, through the open regenerative solenoid valve 4 and the throttle 54 and the air dryer cartridge 44 and the open vent valve 56, to a ventilation outlet 50c. To this end, the ECU 35 switches the governor solenoid valve (control solenoid valve) accordingly, so that compressed air from the compressed-air outlet 50b is output through the open control solenoid valve 14 via an unloader output 50d as a pneumatic control signal which switches off the compressor 55. The vent valve (purge valve) 56 is furthermore switched to its open position via the open control solenoid valve 14 (governor solenoid valve), so that the compressed air conducted through the air dryer cartridge 44 can be conducted to the ventilation output 50c via the open check valve 56.

The use of the control module 1 in the air treatment system 51 of FIG. 5 is furthermore also possible. The first solenoid valve 4 and the second solenoid valve 14 here are both formed as 3/2 solenoid valves, with the functionality of the components shown according to the air treatment system 50 of FIG. 4. In contrast to FIG. 4, however, the vent valve 56 in FIG. 5 is controlled by the regenerative solenoid valve 4. The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “—” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

### LIST OF REFERENCE SIGNS (PART OF THE DESCRIPTION)

1 Control module
2 Module housing
2a First side, in particular upper side of the module housing 2
2b Second side, in particular underside of the module housing 2
2c Mounting surface
3 Cover
3a Upper side of the cover
3b Underside of the cover
3c Outer edge of the cover 3
4 First solenoid valve
5 First coil
7, 8 First connection pins
9 First armature
10 First yoke
11a Valve block of the module housing 2
11b Connection part of the module housing 2
12 Plug-in connection
14 Second solenoid valve
15 Second coil
17, 18 Second connection pins
19 Second armature
20 Second yoke
22 Plug socket
24 Plug-in pins
26 Pneumatic measuring connection
27 Connection socket
28 Printed circuit board, circuit carrier
28a Upper side of the printed circuit board 28
28b Underside of the printed circuit board 28
32 Pressure sensor
33 Sealing ring
35 Electronic control device, microcontroller
36 First pneumatic connection
36a Rubber seal in the first pneumatic connection 36
37 Second pneumatic connection
37a Rubber seal in the second pneumatic connection 37
40 Air dryer
42 Air dryer housing
44 Air dryer cartridge
50, 51 Air treatment system
50a Compressed-air input of the air treatment system 50
50b Compressed-air output
50c Ventilation outlet
50d Unloader output
52 Sound absorber
53 Non-return valve
54 Throttle
55 Compressor
56 Vent valve (purge valve)
60 Electrical connection plug

What is claimed is:

1. A control module for an air treatment system of a commercial vehicle, wherein the control module comprises:
a first pneumatic solenoid valve having a first coil, first connection pins and a first armature accommodated in the first coil,
a second pneumatic solenoid valve having a second coil, second connection pins and a second armature accommodated in the second coil,
a circuit carrier, and
a module housing, which is cast from a plastic material and into which the first coil and the second coil are cast,
wherein
the first and second connection pin project from a first side of the module housing and are electrically connected to the circuit carrier,
a plug-in connection for accommodating a connection plug is formed in the module housing, wherein the plug-in connection has plug-in pins which extend through the module housing, project from the first side of the module housing and are electrically connected to the circuit carrier,
wherein the circuit carrier is covered or protected by a cover, which is fastened on the module housing,
wherein the module housing has a mounting surface for contact with an air dryer housing of an air dryer, and
wherein pneumatic connections of the first solenoid valve and the second solenoid valve are provided or exposed at the mounting surface.

2. The control module as claimed in claim 1, wherein the circuit carrier is pressed onto the connection pins and onto the plug-in pins.

3. The control module as claimed in claim 1, wherein furthermore cast in the module housing are:
a first yoke of the first solenoid valve for forming a first closed magnetic circuit with the first armature, and a second yoke of the second solenoid valve for forming a second closed magnetic circuit with the second armature.

4. The control module as claimed in claim 1, wherein the mounting surface is formed on a lateral surface of the module housing.

5. The control module as claimed in claim 1, wherein the module housing has:
a valve block part, in which the solenoid valves are accommodated and on which the mounting surface is formed, and
a connection part, on which the plug socket and a pneumatic measuring connection are provided,
wherein the mounting surface is formed only on the valve part.

6. The control module as claimed in claim 1, wherein the first armature and the second armature project beyond the mounting surface for direct connection to a connected air dryer.

7. The control module as claimed in claim 1, wherein the plug-in connection is exposed at a second side of the module housing, which is opposite the first side.

8. The control module as claimed in claim 7, wherein a pneumatic measuring connection is formed on the second side of the module housing and a pneumatic connection socket is formed on the first side of the module housing,
wherein the measuring connection and the pneumatic connection socket are pneumatically connected to one another by the module housing, and
a pressure sensor is mounted and contacted on the circuit carrier, which pressure sensor is connected to the pneumatic connection socket of the module housing for pressure measurement at a pneumatic line connected to the measuring connection.

9. The control module as claimed in claim 1, wherein
a pneumatic measuring connection is formed in the mounting surface of the module housing and
a pneumatic connection socket is formed on the first side of the module housing,
wherein the measuring connection and the pneumatic connection socket are pneumatically connected to one another by the module housing,
wherein a pressure sensor is mounted and contacted on the circuit carrier, which pressure sensor is connected to the pneumatic connection socket of the module housing for pressure measurement at a pneumatic line connected to the measuring connection.

10. The control module as claimed in claim 1, wherein an electronic control device is mounted and contacted on the circuit carrier for controlling the solenoid valves.

11. The control module as claimed in claim 1, wherein
a second side of the cover, is formed as a contact surface for contact with the first side of the module housing and
the cover has an outer edge, which is offset laterally outward with respect to the second side of the cover and extends to embrace or encompass the first side of the module housing.

12. The control module as claimed in claim 1, wherein the cover is formed from plastic as a cast part.

13. An air treatment system, comprising:
a control module as claimed in claim 1, and an aid dryer having an air dryer housing and an air dryer cartridge,
wherein the control module lies with its mounting surface against the air dryer housing and the solenoid valves are connected by their pneumatic connections to connections of the air dryer housing.

14. The air treatment system as claimed in claim 13, wherein the first solenoid valve is formed as a regenerative solenoid valve for bypassing a non-return valve between the air dryer and an air pressure output, and the second solenoid valve is formed as a governor solenoid valve or control solenoid valve for outputting a pneumatic unloader control signal to a pneumatic control input of a connected compressor.
